(19) United States
(12) Patent Application Publication
(10) Pub. No.: US 2022/0198548 A1
(43) Pub. Date: Jun. 23, 2022

(54) OPERATING HISTORY AND WORK ORDER DRIVEN DIGITAL TWIN TEMPLATES

(71) Applicant: International Business Machines Corporation, Armonk, NY (US)

(72) Inventors: Lisa Seacat DeLuca, Bozeman, MT (US); Eric B. Libow, Raleigh, NC (US)

(21) Appl. No.: 17/124,837

(22) Filed: Dec. 17, 2020

(51) Int. Cl. G06Q 30/06; G06Q 10/04

(52) U.S. Cl. CPC G06Q 30/0635; G06Q 10/04

(57) ABSTRACT

Generating a digital twin template for a set of physical assets based upon several considerations including a pattern usage analysis that takes into account the current and historical operating data for the set of physical assets. The current and historical operating data for the set of physical assets is processed by an Enterprise Asset Management (EAM) solution to ultimately generate a useful digital twin template for a given user to consistently make informed decisions with respect to the various modes of operating and/or maintaining the set of physical assets.

### BACKGROUND

The present invention relates generally to the field of digital twin templates, and more particularly to the use of an operating digital twin to provide helpful real-time predictive data to a user of a physical asset so that the user can consistently make informed decisions with respect to the operation of the physical asset.

A digital twin is a virtual representation of a physical object or system. Connected sensors on the physical object (i.e., asset) collect real-time data that is mapped to the virtual representation (i.e., model). The model uses the mapped data as input to output predictions or simulations of how the physical asset will be affected by the input. Digital twins integrate the Internet of Things (IoT), artificial intelligence (AI), machine learning (ML), and software analytics to generate the predictions and/or simulations. A digital twin marketplace (or exchange, store, etc.) connects the manufacturers and content providers of various physical assets (e.g., jet aircraft, mining equipment, railroad engines, manufacturing equipment etc.) and the owners/operators of said assets. Content available for purchase from the digital twin store includes, but is not limited to, parts lists, bills of material, user manuals, maintenance/service manuals, and augmented/virtual reality models.

### SUMMARY

According to an aspect of the present invention, there is a method, computer program product and/or system that performs the following operations (not necessarily in the following order): (i) receiving, by an Enterprise Asset Management (EAM) solution, a physical asset data set, with the physical asset data set including information indicative of identities of a plurality of physical assets and usage data for each given physical asset of the plurality of physical assets; (ii) monitoring, by the EAM solution, the usage of the plurality of physical assets based upon the usage data for each given physical asset of the plurality of physical assets; (iii) analyzing, by the EAM solution, the usage data for each given physical asset of the plurality of physical assets to obtain usage pattern data set, with the usage pattern data set including information indicative of patterns of usage of each given physical asset; and (iv) responsive to the analysis, constructing a digital twin template based, at least in part, upon the usage pattern data set.

### BRIEF DESCRIPTION OF THE DRAWINGS

FIG. 1 depicts a cloud computing node used in a first embodiment of a system according to the present invention;

FIG. 2 depicts an embodiment of a cloud computing environment (also called the “first embodiment system”) according to the present invention;

FIG. 3 depicts abstraction model layers used in the first embodiment system;

FIG. 4 is a flowchart showing a first embodiment method performed, at least in part, by the first embodiment system; and

FIG. 5 is a block diagram showing a machine logic (for example, software) portion of the first embodiment system.

### DETAILED DESCRIPTION

Some embodiments of the present invention are directed towards generating a digital twin template for a set of physical assets based upon several considerations including a pattern usage analysis that takes into account the current and historical operating data for the set of physical assets. The current and historical operating data for the set of physical assets is processed by an Enterprise Asset Management (EAM) solution to ultimately generate a useful digital twin template for a given user to consistently make informed decisions with respect to the various modes of operating and/or maintaining the set of physical assets.

This Detailed Description section is divided into the following sub-sections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

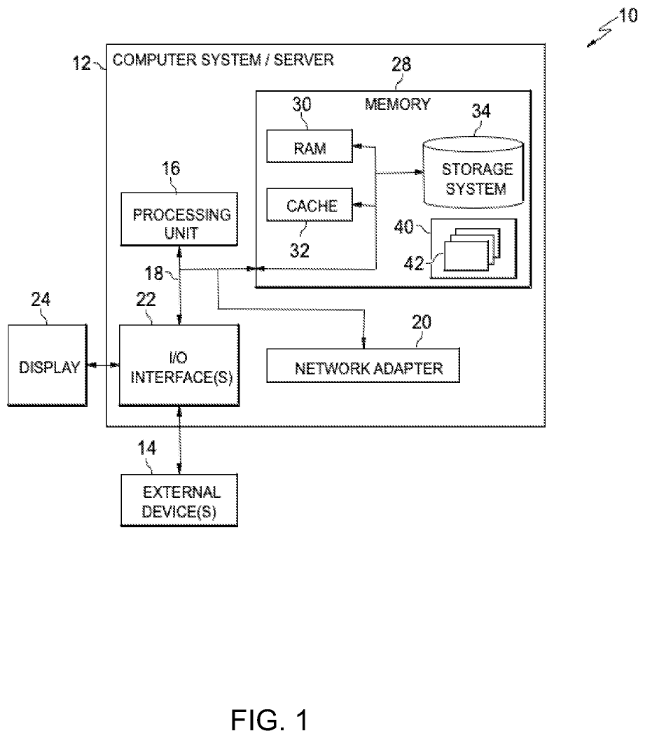

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

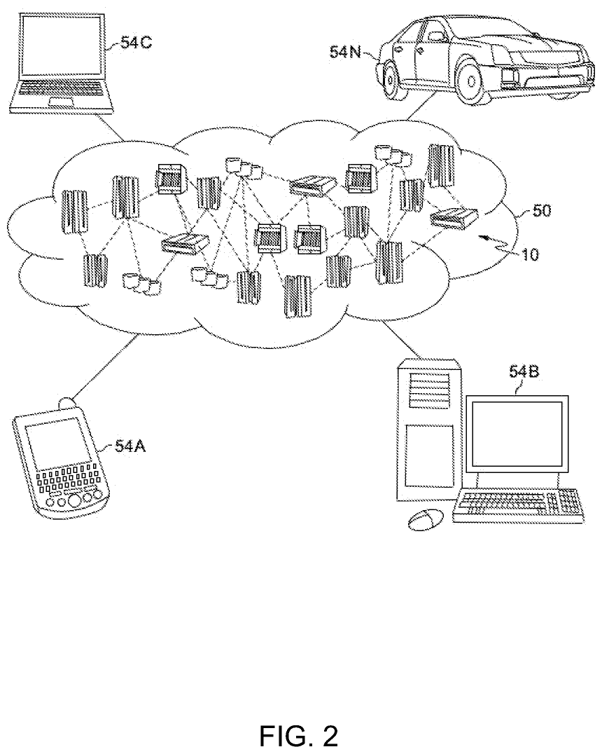

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

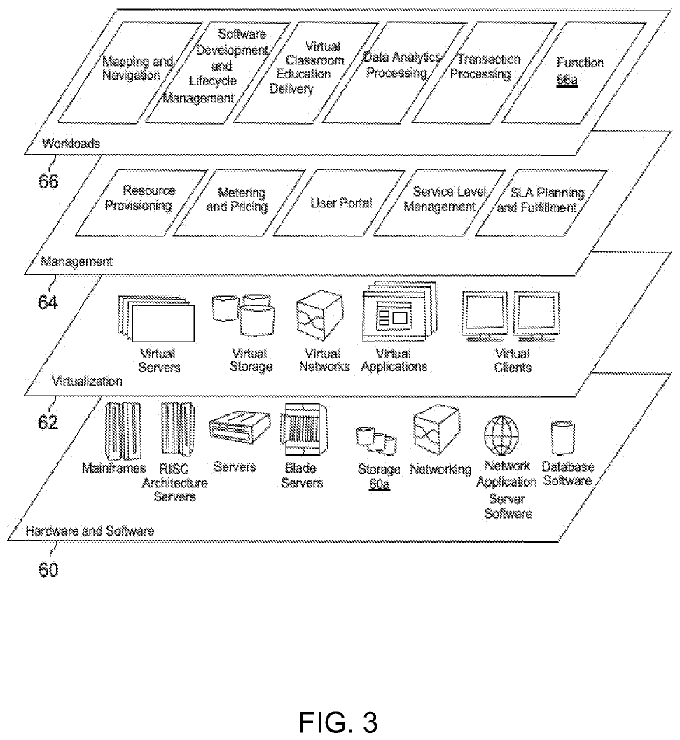

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes; RISC (Reduced Instruction Set Computer) architecture based servers; storage devices; networks and networking components. In some embodiments software components include network application server software.

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and functionality according to the present invention (see function block 66a) as will be discussed in detail, below, in the following sub-sections of this Detailed description section.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

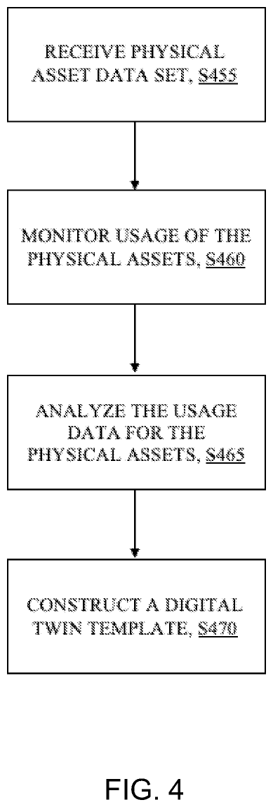

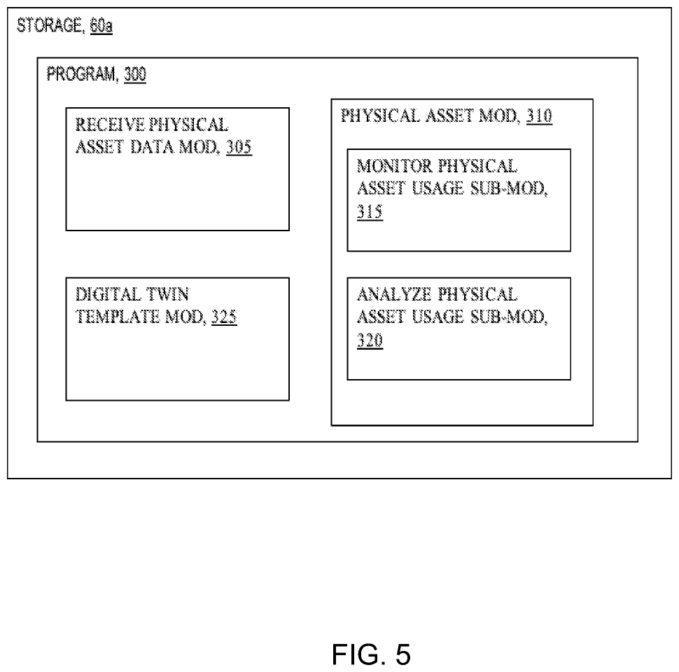

FIG. 4 shows flowchart 450 depicting a method according to the present invention. FIG. 5 shows program 300 for performing at least some of the method operations of flowchart 450. This method and associated software will now be discussed, over the course of the following paragraphs, with extensive reference to FIG. 4 (for the method operation blocks) and FIG. 5 (for the software blocks). One physical location where program 300 of FIG. 5 may be stored is in storage block 60a (see FIG. 3).

Processing begins at operation S455, where receive physical asset data module (“mod”) 305 receives a physical asset data set from a given set of physical assets (such as a fleet of mining vehicles) that have Internet of Things (IoT) capabilities. That is, the physical assets are structured and configured to collect and transmit real-time data pertaining to the operation of the physical assets. Additionally, the physical asset data set includes historical operating data that pertains to how the physical assets have performed over a given period of time. In some instances, the real-time data pertaining to the current operation of a physical asset and the historical operating data is referred to as usage data.

Processing proceeds to operation S460, where monitor physical asset usage sub-module (“sub-mod”) 315 of physical asset mod 310 monitors the usage data received from the given set of physical assets. In some embodiments of the present invention, monitor physical asset usage sub-mod 315 monitors only the real-time data pertaining to the current operation of the given set of physical assets. In this instance, physical asset usage sub-mod 315 monitors usage data that relates primarily to: (i) sensor data received directly from the IoT capable physical assets, and (ii) maintenance data relating to when the given physical asset (or assets) will need to undergo a scheduled or unscheduled maintenance inspection and/or repair. Alternatively, monitor physical asset usage sub-mod 315 monitors the historical operating data for the given set of physical assets.

Processing proceeds to operation S465, where analyze physical asset usage sub-mod 320 of physical asset mod 310 uses predictive analytics to the monitored usage data received from the given set of physical assets (for both real-time operating data and historical operating data) in order to identify patterns of usage for the set of physical assets. These patterns of usage are discussed in greater detail in the Further Comments and/or Embodiments sub-section, below.

Finally, processing proceeds to operation S470, where digital twin template mod 325 constructs a digital twin template based on the patterns of usage identified by analyze physical asset usage sub-mod 320 (as discussed in connection with operation S465, above). In some embodiments, digital twin template mod 325 constructs the digital twin template based upon the identification of an operating model for a given physical asset. Alternatively, digital twin template mod 325 constructs the digital twin template based upon one or more of the following factors: (i) a maintenance plan for the given physical asset; (ii) a stocking strategy for the given physical asset (as well as the parts used to maintain the physical asset); and (iii) a forecast model used to determine when and how often the given physical asset needs to undergo a maintenance procedure and/or the useful lifespan of the given physical asset. In some embodiments of the present invention, digital twin template mod 325 constructs the digital twin template based on the given set of physical assets having a common usage pattern and a set of common environmental factors (such as whether the physical assets can be utilized in a rocky terrain).

### III. Further Comments and/or Embodiments

Some embodiments of the present invention recognize the following facts, potential problems and/or potential areas for improvement with respect to the current state of the art: (i) a proprietary Enterprise Asset Management (EAM) solution tracks the complete lifecycle of an asset's ownership including information about the asset itself and any warranty, maintenance, and work orders performed; (ii) some clients use EAM solutions to manage thousands of their assets, and often times that means duplicates for a particular asset class; (iii) for example, an underground mining truck company might have five hundred (500) of the exact same haul truck; (iv) currently, asset templates can be defined proactively, and then instances of that asset can be created; and (v) what is needed is a way to recognize a pattern between already defined assets to suggest the creation of a digital twin template for digital resources such as operating models, maintenance plans, and stocking strategies.

Some embodiments of the present invention recognize the following facts, potential problems and/or potential areas for improvement with respect to the current state of the art: (i) the idea of templating in the proprietary EAM solution is not new; (ii) currently, manual asset templates are created and are used to help create an asset instance within the proprietary EAM solution for similar assets; (iii) the template option was created to allow a given user to create assets that are of a similar type easily; and (iv) for example, if a given user bought a fleet of pickup trucks that are all identical to one another, a given user can create one template and immediately instantiate 150 new instances.

Some embodiments of the present invention may include one, or more, of the following features, characteristics and/or advantages: (i) uses operational and historical data that is common across an asset class to identify potential asset templates; (ii) generates these templates based on the identified potential asset templates; (iii) publishes these generated templates to a repository; (iv) feeds the digital twin resources into an EAM solution; (v) expands the use of templating based on actual usage (as determined by operating and historical data); (vi) increases the efficiency on third-party users to generate digital twin templates and offer those on the proprietary digital twin exchange.

In some embodiments of the present invention, a given owner or operator can use the proprietary EAM solution by first entering one or more asset identity information into the EAM system. As the asset (or assets) enters operation (that is, the physical asset is being used for its intended purpose), embodiments of the present invention collect and maintain data related to the current and/or future use of that asset. For example, the collected data includes information indicating at least the following: (i) whether a warranty service was performed for the physical asset; (ii) operating history of the physical asset; (iii) parts that are/were replaced on the physical asset; (iv) maintenance schedule data; and/or (v) sensor data taken from the physical asset.

In some embodiments, the asset is compared against assets of a similar type that are: (i) owned and/or operated by the same company; and/or (ii) shared across a given asset network. In some embodiments, preferences are set by the system or the owner/operator of the asset when patterns across the assets triggers the generation of a new digital twin template. These patterns across the assets are determined when the given asset is compared against assets of a similar type.

In some embodiments, when a new digital twin template is triggered, the template can be made in the following forms: (i) operating models (that is, using data that relates to how assets that are similar to the given asset are operated—including asset hierarchies); (ii) maintenance plans (that is, using data from assets that are similar to the given asset relating to the maintenance performed on those assets—either scheduled or ad hoc); (iii) stocking strategies (that is, using data from the similar assets regarding whether certain mechanical and/or electrical parts were replaced, which parts were replaced, and how often those parts were replaced); and (iv) forecast models (that is, using data such as failure modes, sensor data, and the like to generate failure prediction models, degradation curves, etc. so that the system can optimize maintenance costs, determine availability of maintenance opportunities, and provide more accurate forecasts for the life expectancy of a given physical asset).

Alternatively, the generated digital twin template can be shared back with a proprietary digital twin exchange platform.

In some embodiments, along with the digital twin template, metadata can include information as to the reason that the digital twin template was created or recommended to be created. This information includes: (i) number of assets that the digital twin template was shown to have a common pattern with (such as on 500 haul trucks); (ii) percentage of assets with a similar pattern (for example, seventy percent (70%) of pumps; (iii) environmental factors where the digital twin template was seen or not seen (for example, the asset was used in North America or in cold weather conditions); and (iv) a description of the workload performed by the physical asset.

Additionally, along with the digital twin template being on a shared system (such as the proprietary digital twin exchange platform), embodiments of the present invention can recommend various pricing levels based on a multitude of factors. The first factor is a penetration of similar assets. That is, if a large percentage of the assets managed within the enterprise asset management (EAM) system are similar to the physical asset associated with the new digital twin template, then the new template is likely considered to be more valuable and would therefore demand in a higher price. The second factor is the percentage of savings on maintenance costs realized after implementing predictive capabilities (including predicting the most efficient ways to. maintain the given physical asset). Finally, the third factor is the reduction in inventory costs realized based on inventory optimization models. In some embodiments, the EAM system would: (i) continue to monitor the given physical asset; and (ii) determine whether it is necessary to adjust the published digital twin template using machine learning methods.

The following paragraphs provide a practical and illustrative example of implementing embodiments of the present invention.

In this example, person A works for an underground mining company. Person A's company has over 10,000 physical assets managed within the proprietary Enterprise Asset Management (EAM) solution. As each asset is operated: work orders are performed, job plans are created, and relevant mechanical and/or electrical parts are replaced. Person A and his teams across the world track and manage how these assets are used within the proprietary EAM solution.

Here, embodiments of the present invention recognize or begins to recognize some patterns between some of the physical assets (such as a truck). Additionally, in this example, there are five (5) physical assets that are similar to the given physical asset that is being tracked and managed (assets one through five (1-5)). The patterns that are recognized for these physical assets include the following: (i) every three (3) months, scheduled oil changes are performed; (ii) every six (6) months a tire is either replaced or is recommended to be replaced on the truck; (iii) those trucks that are operating in rocky terrain conditions must have their tires replaced every four (4) months; and (iv) the brake pads also wear more in mines that are longer and require more driving from the base operations.

In some embodiments of the present invention, once these patterns are identified, new maintenance plans, stocking strategies, and operating models are generated for various conditions based on the recognized patterns with information to explain why a digital resource was created.

The digital resource provides the following information readout:
(1) Maintenance plan for all like-assets: oil changes performed
(2) Maintenance plan for all like-assets: tires require replacement Stocking strategy: four (3) tires per asset every six (6) months; brake pads
(3) Maintenance plan for all like-assets: rocky terrain resulted in more tire replacements than normal

Stocking strategy: four (4) tires per asset every four (4) months (80% of rocky terrain vehicles required tire replacements every six (6) months

Continuing from the above example, person A applies the information provided in the digital resource to his or her own like-assets within the proprietary EAM system. The system suggests that person A may be able to share his or her physical asset with other owners and operators of those assets on the proprietary digital twin exchange platform for a specified price for the digital twin.

Some embodiments of the present invention may include one, or more, of the following features, characteristics and/or advantages: (i) the digital twin template is based on a set of physical assets that have a common usage pattern with common environmental factors; (ii) uses operational and historical data that is common across an asset class to identify potential asset templates, generate these templates, and publish these templates to a repository; and (iii) identifies patterns to recommend that resources associated with a physical asset should be made available on a digital twin marketplace.

Embodiments of the present invention provide a method for generating a digital twin template based upon a usage analysis of a given set of physical assets. Operations of this method include the following (and not necessarily in the following order): (i) monitoring usage of the set of assets according to a usage history wherein the usage history includes sensor data, operational history, and service; (ii) applying analytic analysis to the usage history to identify patterns of usage; (iii) constructing a digital twin template based on the identified patterns of usage meeting a template forming criteria; and (iv) identifying at least one operating model (such as a maintenance plan, a stocking strategy, and/or a forecast model). In this method, the digital twin template is based on a set of physical assets that have a common usage pattern with common environmental factors.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

User/subscriber: includes, but is not necessarily limited to, the following: (i) a single individual human; (ii) an artificial intelligence entity with sufficient intelligence to act as a user or subscriber; and/or (iii) a group of related users or subscribers.

Data communication: any sort of data communication scheme now known or to be developed in the future, including wireless communication, wired communication and communication routes that have wireless and wired portions; data communication is not necessarily limited to: (i) direct data communication; (ii) indirect data communication; and/or (iii) data communication where the format, packetization status, medium, encryption status and/or protocol remains constant over the entire course of the data communication.

Receive/provide/send/input/output/report: unless otherwise explicitly specified, these words should not be taken to imply: (i) any particular degree of directness with respect to the relationship between their objects and subjects; and/or (ii) absence of intermediate components, actions and/or things interposed between their objects and subjects.

Without substantial human intervention: a process that occurs automatically (often by operation of machine logic, such as software) with little or no human input; some examples that involve “no substantial human intervention” include: (i) computer is performing complex processing and a human switches the computer to an alternative power supply due to an outage of grid power so that processing continues uninterrupted; (ii) computer is about to perform resource intensive processing, and human confirms that the resource-intensive processing should indeed be undertaken (in this case, the process of confirmation, considered in isolation, is with substantial human intervention, but the resource intensive processing does not include any substantial human intervention, notwithstanding the simple yes-no style confirmation required to be made by a human); and (iii) using machine logic, a computer has made a weighty decision (for example, a decision to ground all airplanes in anticipation of bad weather), but, before implementing the weighty decision the computer must obtain simple yes-no style confirmation from a human source.

Automatically: without any human intervention.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer-implemented method (CIM) comprising:
receiving, by an Enterprise Asset Management (EAM) solution, a physical asset data set, with the physical asset data set including information indicative of identities of a plurality of physical assets and usage data for each given physical asset of the plurality of physical assets;
monitoring, by the EAM solution, the usage of the plurality of physical assets based upon the usage data for each given physical asset of the plurality of physical assets;
analyzing, by the EAM solution, the usage data for each given physical asset of the plurality of physical assets to obtain usage pattern data set, with the usage pattern data set including information indicative of patterns of usage of each given physical asset; and
responsive to the analysis, constructing a digital twin template based, at least in part, upon the usage pattern data set.

2. The CIM of claim 1 further comprising:
responsive to the construction of the digital twin template, offering for sale the digital twin template within a digital twin marketplace.

3. The CIM of claim 1 wherein the digital twin template is an asset forecast model.

4. The CIM of claim 1 wherein the usage data includes operational history of each given physical asset of the plurality of physical assets.

5. The CIM of claim 1 wherein the usage data includes maintenance history of each given physical asset of the plurality of physical assets.

6. The CIM of claim 1 wherein the usage data includes sensor data generated by each given physical asset of the plurality of physical assets.

7. A computer program product (CPP) comprising:
a machine readable storage device; and
computer code stored on the machine readable storage device, with the computer code including instructions and data for causing a processor(s) set to perform operations including the following:
receiving, by an Enterprise Asset Management (EAM) solution, a physical asset data set, with the physical asset data set including information indicative of identities of a plurality of physical assets and usage data for each given physical asset of the plurality of physical assets,
monitoring, by the EAM solution, the usage of the plurality of physical assets based upon the usage data for each given physical asset of the plurality of physical assets,
analyzing, by the EAM solution, the usage data for each given physical asset of the plurality of physical assets to obtain usage pattern data set, with the usage pattern data set including information indicative of patterns of usage of each given physical asset, and
responsive to the analysis, constructing a digital twin template based, at least in part, upon the usage pattern data set.

8. The CPP of claim 7 further comprising:
responsive to the construction of the digital twin template, offering for sale the digital twin template within a digital twin marketplace.

9. The CPP of claim 8 wherein the first operating model is an asset forecast model.

10. The CPP of claim 7 wherein the usage data includes operational history of each given physical asset of the plurality of physical assets.

11. The CPP of claim 7 wherein the usage data includes maintenance history of each given physical asset of the plurality of physical assets.

12. The CPP of claim 7 wherein the usage data includes sensor data generated by each given physical asset of the plurality of physical assets.

13. A computer system (CS) comprising:
a processor(s) set;
a machine readable storage device; and
computer code stored on the machine readable storage device, with the computer code including instructions and data for causing the processor(s) set to perform operations including the following:
receiving, by an Enterprise Asset Management (EAM) solution, a physical asset data set, with the physical asset data set including information indicative of identities of a plurality of physical assets and usage data for each given physical asset of the plurality of physical assets,
monitoring, by the EAM solution, the usage of the plurality of physical assets based upon the usage data for each given physical asset of the plurality of physical assets,
analyzing, by the EAM solution, the usage data for each given physical asset of the plurality of physical assets to obtain usage pattern data set, with the usage pattern data set including information indicative of patterns of usage of each given physical asset, and
responsive to the analysis, constructing a digital twin template based, at least in part, upon the usage pattern data set.

14. The CS of claim 13 further comprising:
responsive to the construction of the digital twin template, offering for sale the digital twin template within a digital twin marketplace.

15. The CS of claim 14 wherein the first operating model is an asset forecast model.

16. The CS of claim 13 wherein the usage data includes operational history of each given physical asset of the plurality of physical assets.

17. The CS of claim 13 wherein the usage data includes maintenance history of each given physical asset of the plurality of physical assets.

18. The CS of claim 13 wherein the usage data includes sensor data generated by each given physical asset of the plurality of physical assets.
